(19) United States
(12) Patent Application Publication
(10) Pub. No.: US 2025/0080893 A1
(43) Pub. Date: Mar. 6, 2025

(54) BONE CONDUCTION VIBRATION SOUND PRODUCING APPARATUS AND WEARABLE DEVICE

(71) Applicant: Suzhou Thor Electronic Technology Co., Ltd., Jiangsu (CN)

(72) Inventors: Zhiyong TAO, Jiangsu (CN); Juan Chen, Jiangsu (CN); Hongbin CAO, Jiangsu (CN)

(73) Assignee: Suzhou Thor Electronic Technology Co., Ltd., Jiangsu (CN)

(21) Appl. No.: 18/951,600

(22) Filed: Nov. 18, 2024

Related U.S. Application Data
(63) Continuation of application No. PCT/CN2023/094637, filed on May 17, 2023.

(30) Foreign Application Priority Data
May 19, 2022 (CN) 202210557598.9

(51) Int. Cl. H04R 1/10

(52) U.S. Cl. CPC H04R 1/10; H04R 2460/13

(57) ABSTRACT

The present invention discloses a bone conduction vibration sound producing apparatus and a wearable device. The bone conduction vibration sound producing apparatus includes a housing, a vibration assembly, a coil, and two elastic members. The housing is provided with an accommodating cavity. A flexible circuit board connected to the coil is disposed outside the housing. The flexible circuit board is disposed at an end of the housing in a length direction, and is configured to be connected to an external control circuit. The vibration assembly is provided in the accommodating cavity. The coil is fixed with respect to the housing and surrounds an outer periphery of the vibration assembly. The two elastic members are respectively connected to two ends of the vibration assembly and are both connected to the housing.

### CROSS-REFERENCE TO RELATED APPLICATIONS

This application is a continuation of international PCT application serial no. PCT/CN2023/094637, filed on May 17, 2023, which claims the priority benefit of China application no. 202210557598.9, filed on May 19, 2022. The entirety of each of the above-mentioned patent applications is hereby incorporated by reference herein and made a part of this specification.

### TECHNICAL FIELD

The present invention relates to the field of bone conduction technologies, and in particular to a bone conduction vibration sound producing apparatus and a wearable device.

### RELATED ART

Bone conduction sound transmission is a conduction manner that causes hearing through bones. Wearable devices such as bone conduction headsets and bone conduction glasses generate vibration through a bone conduction vibration sound producing apparatus, so that a person hears sound.

The bone conduction vibration sound producing apparatus usually includes a housing, a vibration assembly disposed in the housing, an elastic piece connected between the housing and the vibration assembly, and a coil that drives the vibration assembly to vibrate. The vibration assembly is magnetic, vibrates under the action of a magnetic field of the coil being energized, and may be reset under the action of the elastic piece.

The vibration assembly is provided with the elastic piece at only one end of the vibration assembly to be connected to the housing, and the other end of the vibration assembly is suspended. The vibration assembly may generate a rolling vibration phenomenon of swinging transversely during vibration. This situation is particularly intense in a case that the vibration assembly has a narrow strip shape. If rolling vibration occurs, the vibration assembly tends to hit an external component in a vibration process to generate noise, which affects sound quality and easily damages the component.

In addition, a mounting space of the bone conduction vibration sound producing apparatus is small. An existing elastic piece usually includes an annular outer support, a plate body disposed at a center of the outer support, and a plurality of elastic arms connected between the plate body and the outer support. The plate body is connected to the vibration assembly, and the vibration assembly is driven to be reset by elastic forces of the elastic arms. Because the bone conduction vibration sound producing apparatus has a small size, elastic arms of an elastic piece of an existing structure have short lengths and small widths, which is not conducive to improving the acoustic quality and reliability of the bone conduction vibration sound producing apparatus.

Therefore, it is necessary to improve existing technologies to overcome the shortcomings in existing technologies.

### SUMMARY OF INVENTION

An objective of the present invention is to provide a bone conduction vibration sound producing apparatus and a wearable device, so that a rolling vibration phenomenon of a vibration assembly in a vibration process can be mitigated.

To achieve the foregoing inventive objectives, according to a first aspect, the present invention provides a bone conduction vibration sound producing apparatus, including:
a housing, provided with an accommodating cavity, a flexible circuit board connected to a coil being disposed outside the housing, and the flexible circuit board being disposed at an end of the housing in a length direction, and being configured to be connected to an external control circuit;
a vibration assembly, provided in the accommodating cavity;
the coil, fixed with respect to the housing and surrounding an outer periphery of the vibration assembly; and
two elastic members, the two elastic members being respectively connected to two ends of the vibration assembly, and being both connected to the housing.

According to a second aspect, the present invention provides a wearable device, including the bone conduction vibration sound producing apparatus described above.

Compared with existing technologies, the present invention has the following beneficial effects:

According to some embodiments of the present invention, the elastic members are disposed at both ends of the vibration assembly to support and limit the vibration assembly, which can effectively improve linearity during vibration of the vibration assembly and avoid a rolling vibration phenomenon. In addition, according to some embodiments of the present invention, the elastic member includes an outer support and a connecting arm extending in a length direction of the outer support, so that a limited space can be fully utilized, and a length and a width of the connecting arm can be increased. In one aspect, the connecting arm can provide a reset force more reliably, and in another aspect, the connection between the connecting arm and the vibration assembly can be firmer, thereby further mitigating a rolling vibration phenomenon.

### BRIEF DESCRIPTION OF DRAWINGS

FIG. 1 is a schematic structural diagram of a bone conduction vibration sound producing apparatus according to an implementation of the present invention.

FIG. 2 is a top view of the bone conduction vibration sound producing apparatus in FIG. 1.

FIG. 3 is a cross-sectional view taken along a sectional line C-C in FIG. 2.

FIG. 4 is a schematic structural diagram of an elastic member according to an implementation of the present invention, where an outer support is annular.

FIG. 5 is a front view of the elastic member in FIG. 4.;

FIG. 6 is a cross-sectional view of a bone conduction vibration sound producing apparatus according to an implementation of the present invention, where a thickness of a connecting portion is greater than a thickness of an elastic portion.

FIG. 7 is a cross-sectional view of a bone conduction vibration sound producing apparatus according to an implementation of the present invention, where a connecting portion protrudes toward a vibration assembly.

FIG. 8 is a cross-sectional view of a bone conduction vibration sound producing apparatus according to an implementation of the present invention, where a spacer plate is connected between a connecting portion and a vibration assembly.

FIG. 9 is a schematic structural diagram of an elastic member according to an implementation of the present invention.

FIG. 10 is a schematic structural diagram of a housing of the bone conduction vibration sound producing apparatus in FIG. 1.

FIG. 11 is a three-dimensional cross-sectional view of a housing of the bone conduction vibration sound producing apparatus in FIG. 1.

FIG. 12 is a front view of a housing of the bone conduction vibration sound producing apparatus in FIG. 1.

FIG. 13 is a schematic diagram of a coil being mounted in a mounting hole of a housing according to the present invention.

FIG. 14 is a schematic structural diagram of a housing according to an implementation of the present invention, where the housing includes an upper casing and a lower casing.

FIG. 15 is a schematic diagram of positions of a vibration assembly and a coil according to an implementation of the present invention, where the vibration assembly is formed by connecting a plurality of parts.

FIG. 16 is a schematic diagram of positions of a vibration assembly and a coil according to an implementation of the present invention, where the vibration assembly is a single part.

FIG. 17 is a schematic diagram of positions of a vibration assembly and a coil according to an embodiment of the present invention, where two coils are provided.

### DESCRIPTION OF EMBODIMENTS

To make the foregoing objectives, features, and advantages of this application more comprehensible, the following describes specific implementations of this application in detail with reference to the accompanying drawings. It may be understood that the specific embodiments described herein are merely used for explaining this application, but are not intended to limit this application. In addition, it should be further noted that for ease of description, only parts related to this application rather than all structures are shown in the accompanying drawings. All other embodiments obtained by a person of ordinary skill in the art based on the embodiments of this application without creative efforts shall fall within the protection scope of this application.

The terms “include”, “have”, and any variations thereof in this application are intended to cover a non-exclusive inclusion. For example, a process, method, system, product, or device that includes a series of steps or units is not limited to the listed steps or units, but optionally further includes a step or unit that is not listed, or optionally further includes another step or unit that is inherent to the process, method, product, or device.

The “embodiment” mentioned in this specification means that a particular feature, structure, or characteristic described in combination with the embodiments may be included in at least one embodiment of this application. The term appearing at various positions in the specification does not necessarily refer to the same embodiment or an independent or alternative embodiment that is mutually exclusive with another embodiment. A person skilled in the art explicitly or implicitly understands that the embodiments described in this specification may be combined with other embodiments.

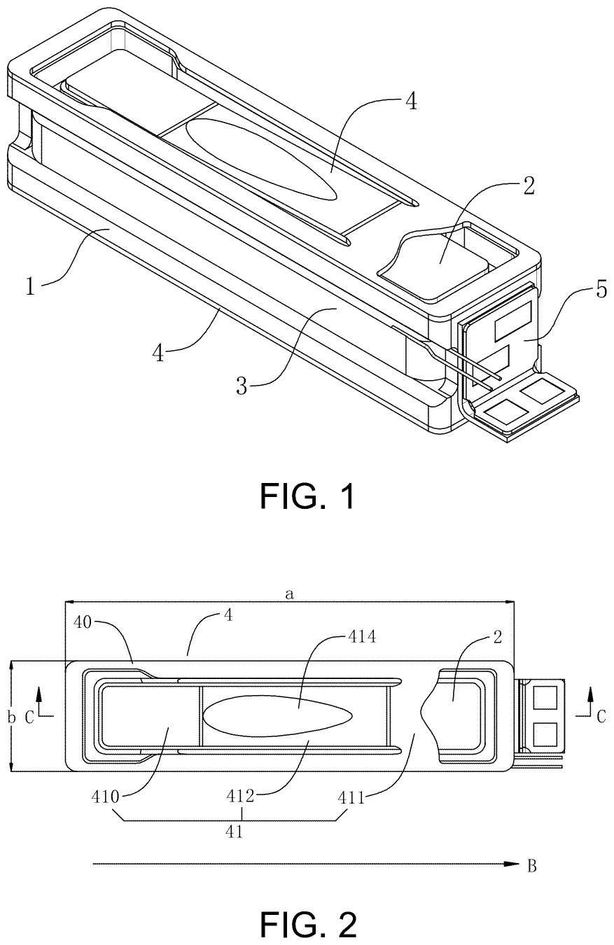

As shown in FIG. 1 to FIG. 15, a bone conduction vibration sound producing apparatus corresponding to a preferred embodiment of the present invention includes a housing 1, a vibration assembly 2, a coil 3, and an elastic member 4.

The bone conduction vibration sound producing apparatus is generally strip-shaped, and correspondingly, the vibration assembly 2, the coil 3, and the elastic member 4 of the bone conduction vibration sound producing apparatus are also strip-shaped. Length directions of the bone conduction vibration sound producing apparatus, the housing 1, the vibration assembly 2, the coil 3, and the elastic member 4 are consistent. An arrow B in FIG. 2 shows the length direction. It may be understood that the strip-shaped bone conduction vibration sound producing apparatus is more suitable for being mounted in a strip-shaped space. For example, for bone conduction glasses, the strip-shaped bone conduction vibration sound producing apparatus is more suitable for being mounted in a strip-shaped temple with little impact on the shape of the temple.

The housing 1 is a mounting carrier for the vibration assembly 2, the coil 3, and the elastic member 4, and is provided with an accommodating cavity 10. The housing 1 may be made of, for example, a material such as plastic, aluminum, or stainless steel.

The vibration assembly 2 is disposed in the accommodating cavity 10, and the vibration assembly 2 can vibrate along a vibration axis A when the bone conduction vibration sound producing apparatus operates. As a preferred implementation, the housing 1 is provided with an opening along two ends in a direction of the vibration axis A. An area of the opening is greater than a cross-sectional area of the vibration assembly 2. The vibration assembly 2 can be mounted in the accommodating cavity 10 through the opening, making assembly more convenient.

The coil 3 is fixed with respect to the housing 1 and surrounds an outer periphery of the vibration assembly 2. The coil 3 can be energized to generate a changing magnetic field, to cause the vibration assembly 2 to vibrate under interaction with the magnetic field. In other words, the coil 3 is configured to drive the vibration assembly 2 to vibrate. As shown in FIG. 1, a flexible circuit board 5 connected to the coil 3 by a wire is disposed outside the housing 1. The flexible circuit board 5 is connected to an external control circuit. The coil 3 is controlled by the external control circuit to drive the vibration assembly 2 to vibrate.

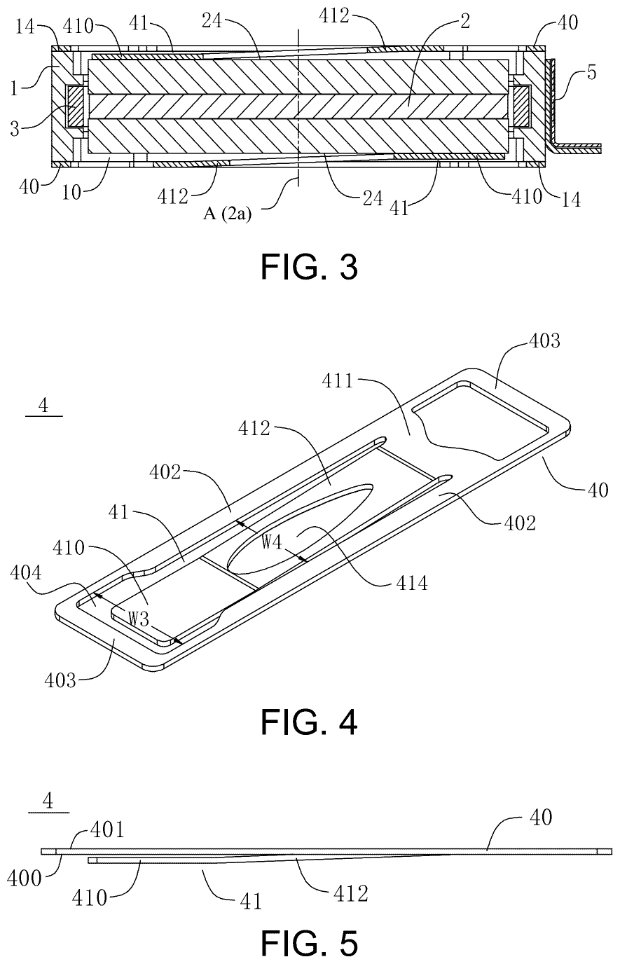

As shown in FIG. 1, FIG. 3, and FIG. 4, two elastic members 4 are provided. The two elastic members 4 are respectively connected to two ends of the vibration assembly 2. In some embodiments, a flat first end surface 24 is provided at each of two ends of the vibration assembly 2 in a vibration direction (i.e., a vibration axis direction). Two connecting arms 41 are respectively connected to the two first end surfaces 24, for example, in a manner of welding, bonding, or the like. The elastic member 4 is generally sheet-shaped, and includes an outer support 40 and the connecting arm 41. The outer support 40 is connected to the housing 1. One end of the connecting arm 41 is connected to the outer support 40, and the other end of the connecting arm 41 extends in the length direction of the elastic member 4 and is connected to the vibration assembly 2. In a vibration process, the connecting arm 41 provides an elastic force for driving the vibration assembly 2 to be reset. The elastic member 4 may be made of a material such as stainless steel, plastic, or beryllium copper.

The two ends of the vibration assembly 2 can both support and limit the elastic member 4. Therefore, compared with a case in which one end is suspended, the vibration assembly 2 can linearly vibrate more reliably, and is not prone to a rolling vibration phenomenon. In addition, the connecting arm 41 extends in the length direction of the elastic member 4. Therefore, a length of the connecting arm 41 can be made larger, and an elastic deformation amount is correspondingly larger, which helps to increase an amplitude and improve a low frequency effect. In addition, a width of the connecting arm 41 can also be made larger, and a connection area between the connecting arm 41 and the vibration assembly 2 is larger, so that the connection is firmer.

As shown in FIG. 4, the connecting arm 41 is generally plate-shaped, and includes a base portion 411 connected to the outer support 40, a connecting portion 410 connected to the vibration assembly 2, and an elastic portion 412 connected between the base portion 411 and the connecting portion 410. In a vibration process of the vibration assembly 2, the base portion 411 is fixed, the connecting portion 410 vibrates with the vibration assembly 2, and the elastic portion 412 elastically deforms with displacement of the vibration assembly 2, to provide an elastic force for driving the vibration assembly 2 to be reset. The connecting arm 41 extends from the base portion 411 in the length direction of the elastic member 4, so that a length of the elastic portion 412 can be made larger, and a length of the connecting portion 410 can also be adjusted as required. In addition, because a space in the outer support 40 can be fully utilized, widths of the elastic portion 412 and the connecting portion 410 can be made larger, thereby improving stiffness and strength of the elastic portion 412, and improving the firmness of the connection between the connecting portion 410 and the vibration assembly 2, so that the bone conduction vibration sound producing apparatus has better operating reliability.

In addition to controlling the width of the elastic portion 412, the strength and stiffness of the elastic portion 412 may be further adjusted by providing a hollowed-out hole 414 in the elastic portion 412. One or more hollowed-out holes 414 may be provided, and the strength and stiffness of the elastic portion 412 can be changed by controlling an area of the hollowed-out hole 414.

In some embodiments, referring to FIG. 3, the vibration assembly 2 is a symmetrical body, and includes a plane 2a of symmetry (the plane 2a of symmetry coincides with the vibration axis A in the figure) perpendicular to the length direction of the vibration assembly 2. The connecting portion 410 and the base portion 411 of the elastic member 4 are respectively located on two sides of the plane 2a of symmetry, so that the length of the connecting arm 41 is larger. It may be understood that when the base portion 411 is connected to an end portion of the outer support 40 in the length direction, a longer connecting arm 41 can be obtained. Certainly, a specific length of the connecting arm 41 may be adjusted according to an actual requirement.

The connecting portion 410 and the base portion 411 are respectively located on the two sides of the plane 2a of symmetry. Therefore, to make force bearing of the vibration assembly 2 more symmetric and balanced, the connecting arms 41 of the two elastic members 4 are disposed to be centrosymmetric, and are centrosymmetric with respect to a center of gravity of the vibration assembly 2 (the center of gravity of the vibration assembly 2 coincides with a geometric center of the vibration assembly 2), so that the two connecting portions 410 have equal distances from the center of gravity of the vibration assembly 2, and forces applied by the elastic member 4 to an upper end surface and a lower end surface of the vibration assembly 2 are more balanced and symmetric. In addition, a projection of the connecting arm 41 along the vibration axis A is basically located in the first end surfaces 24 of the vibration assembly 2, so that a rolling vibration phenomenon can be further avoided. Further optionally, the two elastic members 4 are disposed centrosymmetrically.

It may be understood that when the connecting portion 410 is closer to an end portion of the vibration assembly 2 in the length direction of the vibration assembly 2, a longer connecting arm 41 can usually be obtained.

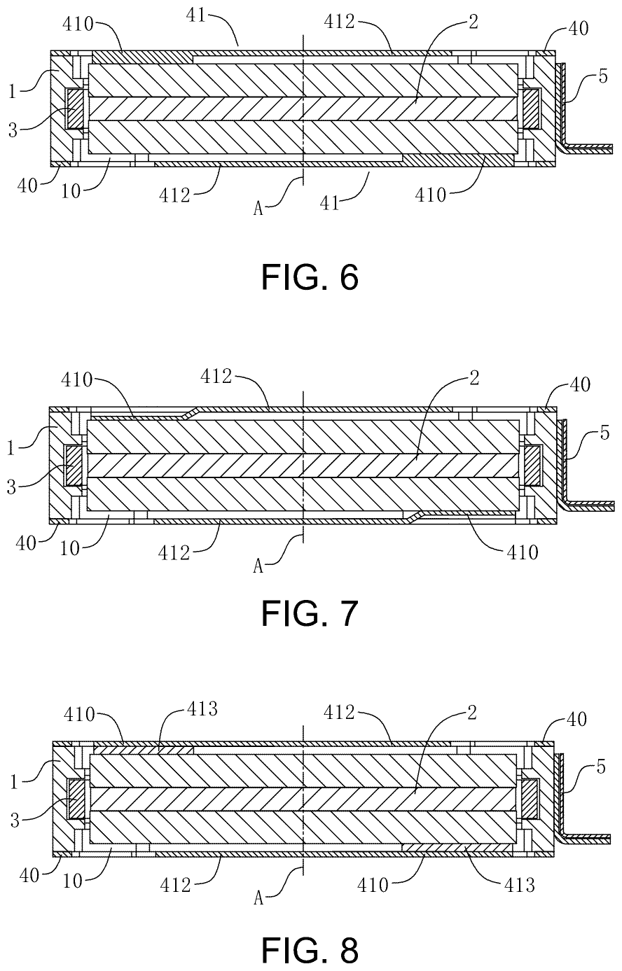

The vibration assembly 2 requires a particular vibration space in the vibration process, and avoids interference with the base portion 411 and the elastic portion 412 of the connecting arm 41. In a first preferred embodiment, referring to FIG. 3 to FIG. 5, the elastic portion 412 is disposed obliquely toward a side on which the vibration assembly 2 is located. In this way, the connecting portion 410 and the elastic portion 412 of the connecting arm 41 protrude from the outer support 40 into the accommodating cavity 10, to form a space for the vibration assembly 2 to vibrate between the connecting portion 410 and the outer support 40. In a second preferred embodiment, referring to FIG. 6, the connecting arm 41 has a shape of a flat plate. The connecting portion 410 and the elastic portion 412 are located in the same plane. A thickness of the connecting portion 410 is set to be greater than a thickness of the elastic portion 412, and the connecting portion 410 protrudes toward the side on which the vibration assembly 2 is located with respect to the elastic portion 412. In this way, the vibration assembly 2 and the elastic portion 412 are separated by the connecting portion 410, to form the space for the vibration assembly 2 to vibrate. In a third preferred embodiment, referring to FIG. 7, the connecting portion 410 protrudes toward the side on which the vibration assembly 2 is located with respect to the elastic portion 412 in a bent manner, to form the space for the vibration assembly 2 to vibrate. In this embodiment, the thickness of the connecting portion 410 may be less than, greater than, or equal to the thickness of the elastic portion 412. In a fourth preferred embodiment, referring to FIG. 8, a difference between the fourth preferred embodiment and the second preferred embodiment lies in that the connecting portion 410 and the elastic portion 412 of the connecting arm 41 have the same thickness. A spacer plate 413 is disposed between the connecting portion 410 and the vibration assembly 2 to separate the vibration assembly 2 and the elastic portion 412 to form the space for the vibration assembly 2 to vibrate.

As a preferred implementation, referring to FIG. 3 to FIG. 5, the housing 1 is provided with an opening along the two ends of the vibration assembly 2 in the vibration direction. For ease of description, an end surface of an opening end of the housing 1 is referred to as a second end surface 14. The outer supports 40 of the two elastic members 4 are respectively connected to the second end surface 14. A connecting manner may be, for example, a bonding connection or a welding connection. The outer support 40 includes a first surface 400 connected to the second end surface 14 and a second surface 401 disposed in parallel with respect to the first surface 400. During mounting of the bone conduction vibration sound producing apparatus, the outer support 40 of the bone conduction vibration sound producing apparatus may be connected to an external part, for example, is connected to a panel in contact with a human face of a wearable device to transfer vibration to the panel. Preferably, in the vibration process of the vibration assembly 2, the connecting arm 41 does not protrude from the second surface 401 of the outer support 40. In this way, a structure for avoiding the connecting arm 41 does not need to be disposed for a part connected to the outer support 40, so that the structure can be simplified. Apparently, in the embodiment in which the elastic portion 412 is disposed obliquely shown in FIG. 3 to FIG. 5, the connecting arm 41 may be adjusted not to protrude from the outer support 40 in the vibration process by controlling a distance between the outer support 40 and the vibration assembly 2 located in an original position.

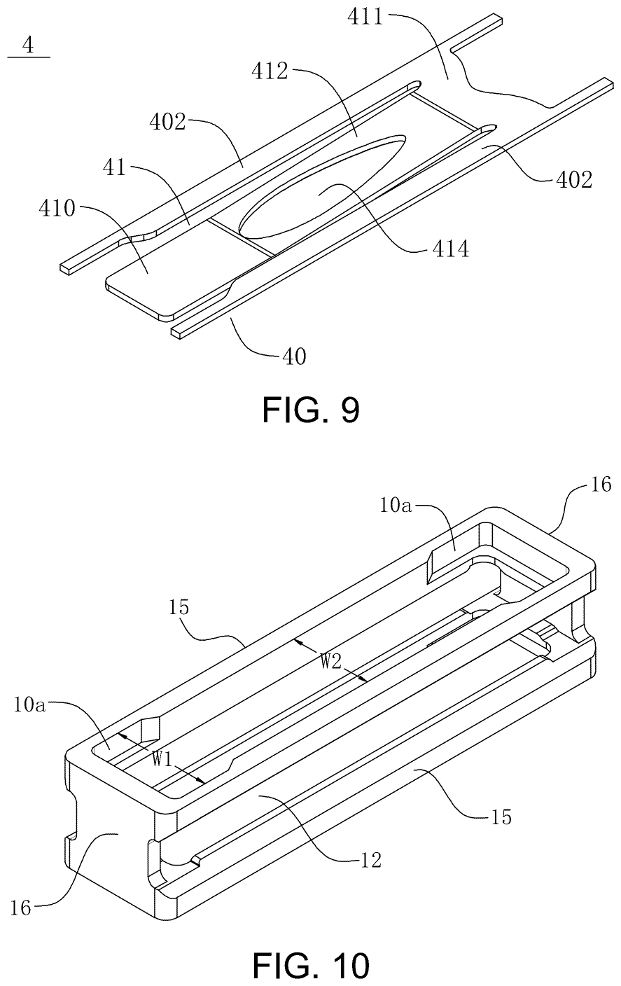

As shown in FIG. 9, the outer support 40 is configured to fix the elastic member 4 on the housing 1, and includes two first rod bodies 402. The base portion 411 is connected between the two first rod bodies 402. Preferably, the two first rod bodies 402 are disposed in parallel, and the base portion 411 is connected to both the two first rod bodies 402. The lengths of the two first rod bodies 402 may be the same or may be different. In a preferred implementation, the two first rod bodies 402 of the outer support 40 may be independent parts, and are not connected. In another preferred implementation, the outer support 40 is annular, and further includes second rod bodies 403 that are respectively connected between the two first rod bodies 402. As shown in FIG. 4, the second rod bodies 403 are connected to end portions of the two first rod bodies 402, and the entire outer support 40 is rectangularly annular. When the outer support 40 is annular, the structural strength and stiffness of the outer support 40 are better, and the connection with the outer support 40 is usually firmer. Optionally, as shown in FIG. 4, FIG. 9, and FIG. 10, a wider part 10a with a width W1 greater than a width W2 of the remaining part of the accommodating cavity 10 is provided at each of two ends of the accommodating cavity 10 in a length direction, and the wider part 10a is in communication with the second end surface 14 of the housing 1 adjacent to the wider part 10a. A width W3 of each of two ends of a cavity 404 configured to accommodate the connecting arm 41 of the outer support 40 in a length direction is greater than a width W4 of the remaining part of the cavity 404, to facilitate positioning of the vibration assembly 2 in an assembly process of the bone conduction vibration sound producing apparatus. When the outer support 40 is annular, the cavity 404 configured to accommodate the connecting arm 41 of the outer support 40 is an inner hole of the outer support 40.

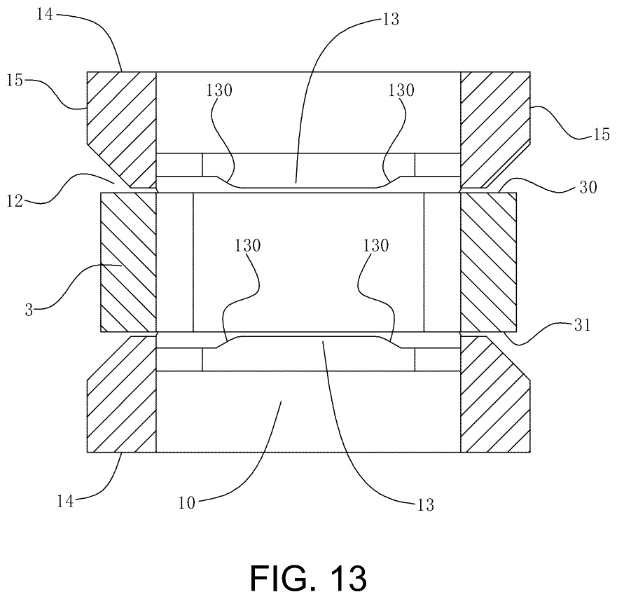

The housing 1 includes two second end surfaces 14 located at an upper end and a lower end and an outer peripheral surface located between the two second end surfaces 14. As shown in FIG. 10 and FIG. 13, a case of the shape of the housing 1 has a cuboidal shape is used as an example. The outer peripheral surface of the housing 1 includes two first side surfaces 15 disposed opposite and two second side surfaces 16 disposed opposite, the first side surfaces 15 extend in the length direction of the housing 1, the second side surfaces 16 extend in a width direction of the housing 1, and a height direction of the housing 1 is consistent with the direction of the vibration axis A. A mounting hole 12 configured to mount the coil 3 is opened in the outer peripheral surface of the housing 1. In this embodiment, the mounting hole 12 is opened in the first side surfaces 15. In other embodiments, the mounting hole 12 may be opened in the second side surface 16.

In a preferred implementation, the mounting hole 12 is a blind hole, is opened in the first side surface 15, extends in a direction perpendicular to the first side surface 15, but is not in communication with the first side surface 15 on the other side. In this implementation, the coil 3 is pushed to the bottom through the mounting hole 12 to complete mounting. In another preferred implementation, as shown in FIG. 13, the mounting hole 12 is a through hole, penetrates the housing 1, and communicates the two first side surfaces 15. In this implementation, the coil 3 may be pushed from two sides of the housing 1 for mounting.

To facilitate the pushing of the coil 3, an opening of the mounting hole 12 has a horn shape. In other words, the opening of the mounting hole 12 gradually expands toward an outside, so that the coil 3 can be guided to be mounted in the mounting hole 12, thereby facilitating the assembly of the coil 3.

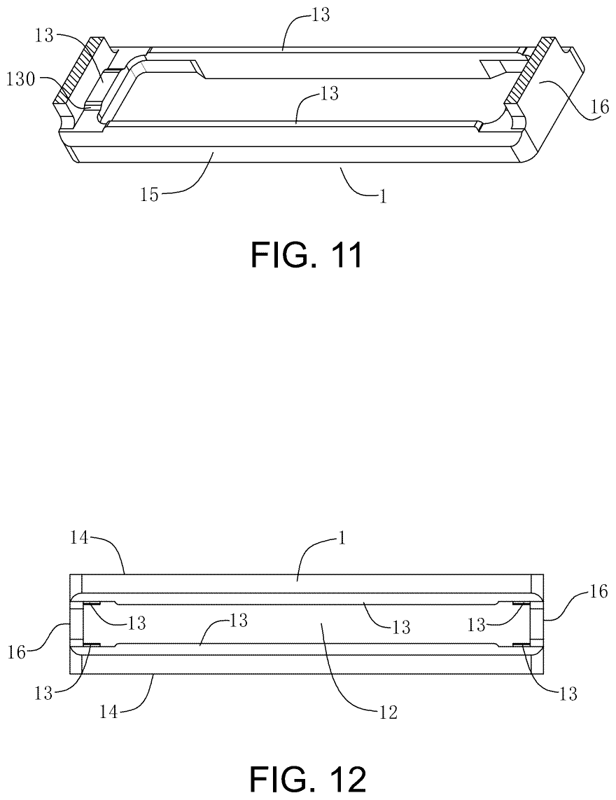

Further, referring to FIG. 11 to FIG. 13, one or more bosses 13 protruding into the mounting hole 12 are disposed on the housing 1. The boss 13 protrudes along the vibration axis A of the vibration assembly 2, to reduce a distance of the mounting hole 12 in a height direction, thereby limiting the coil 3 in the height direction. The housing I may be provided with only a boss 13 disposed facing an upper end surface 30 of the coil 3, or may be provided with only a boss 13 disposed facing a lower end surface 31 of the coil 3, or may be provided with a plurality of bosses 13 that respectively correspond to the upper end surface 30 and the lower end surface 31 of the coil 3. The boss 13 is arranged, so that the position of the coil 3 in the height direction can be limited more precisely, and in addition, the fitting precision between the coil 3 and another part of the mounting hole 12 is reduced, thereby reducing processing costs. Preferably, the coil 3 abuts against the boss 13. The coil 3 and the housing 1 are preferably connected through bonding. The arrangement of the boss 13 further helps to form a gap for accommodating glue between the coil 3 and a hole surface of the mounting hole 12, so that the mounting of the coil 3 is firmer.

As a preferred implementation, the housing 1 includes two boss groups that are respectively located on an upper side and a lower side of the coil 3. Each boss group includes four bosses 13 that respectively correspondingly abut against two long sides and two short sides of the coil 3, so that a limiting effect is better. As shown in FIG. 11 and FIG. 13, a transition surface 130 is provided at the boss 13 corresponding to the short side, and the transition surface 130 may be inclined or arc-shaped, to further guide the coil 3 to be mounted in the mounting hole 12.

It may be understood that because the coil 3 can protrude from the accommodating cavity 10 of the housing 1, an outer periphery of the coil 3 is not completely surrounded by the housing 1. Therefore, a space can be more fully utilized, thereby improving the compactness of the integral structure and facilitating the miniaturization of the bone conduction vibration sound producing apparatus. In addition, the coil 3 is exposed from the housing 1, and has a better heat dissipation effect.

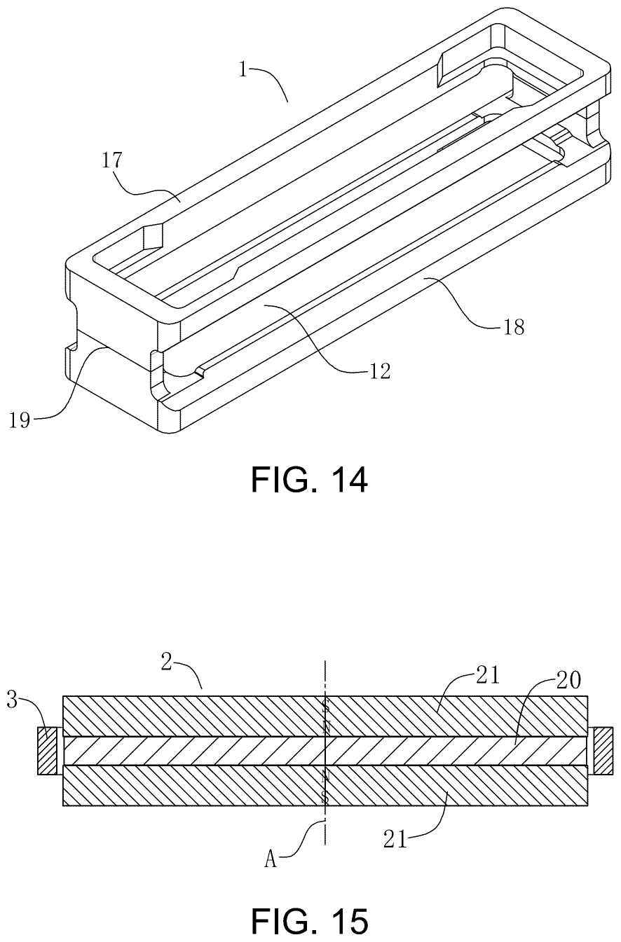

Apart from being disposed as an integral structure (integrally formed), the housing 1 may be formed by connecting a plurality of parts. Preferably, as shown in FIG. 14, the housing 1 includes an upper casing 17 and a lower casing 18, and is formed by connecting the upper casing 17 and the lower casing 18. A connecting surface 19 of the two casings passes through the mounting hole 12, so that the mounting hole 12 is at least partially located in one of the casings, and is opened at the connecting surface 19. In this way, during mounting of the coil 3, the coil 3 may be first mounted in the mounting hole 12 of the upper casing 17 or the lower casing 18, and subsequently, the other casing and the casing are welded into the housing 1 to implement the assembly of the coil 3 in the housing 1, so that an assembly procedure can be simplified, thereby facilitating assembly.

In a preferred implementation, as shown in FIG. 15, the vibration assembly 2 is formed by connecting a plurality of parts. Specifically, the vibration assembly 2 includes a magnetic conductive plate 20 and two magnets 21 connected at two ends of the magnetic conductive plate 20. The two magnets 21 are disposed with same poles facing each other. For example, N poles of the two magnets 21 are adjacent, and S poles are located at two end portions of the vibration assembly 2. The coil 3 surrounds an outer periphery of the magnetic conductive plate 20. Magnetic field lines of the two magnets 21 can pass through the coil 3 in a more concentrated manner, thereby improving the utilization of the magnetic field, and improving the sensitivity and driving force of the vibration of the vibration assembly 2. Preferably, an upper end and a lower end of the coil 3 protrude to an outside of the magnetic conductive plate 20 and surround the two magnets 21, thereby further improving the utilization of the magnetic field. In the embodiment shown in FIG. 15, the magnets 21 and the magnetic conductive plate 20 are arranged in the vibration direction of the vibration assembly 2.

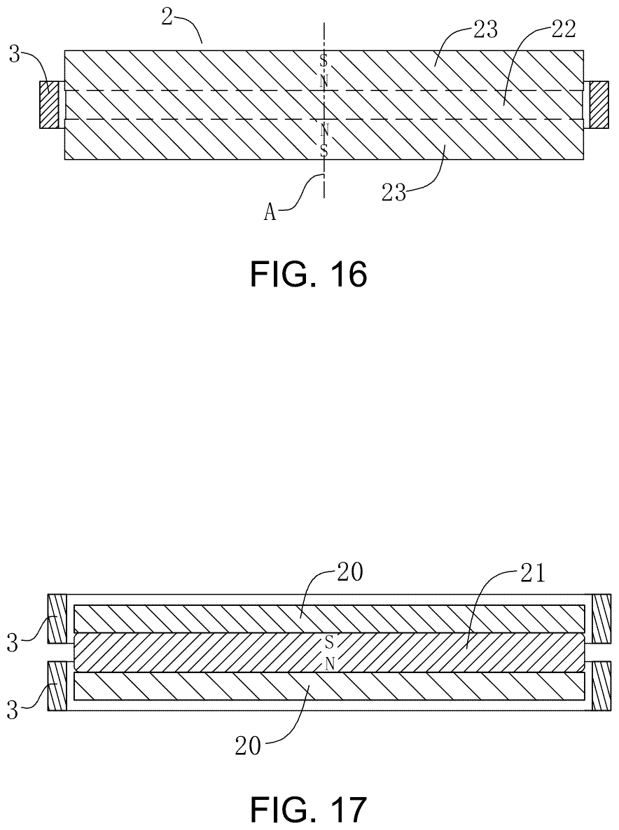

In a preferred implementation, referring to FIG. 16, the vibration assembly 2 is an integral single part. A magnetic conductive portion 22 and two magnetic portions 23 that are respectively located on two sides of the magnetic conductive portion 22 are formed on the vibration assembly 2 in a manner of magnetizing a magnetic conductive material. The magnetic conductive portion 22 and the magnetic portions 23 are all parts of the vibration assembly 2 rather than single parts. FIG. 16 shows boundaries between the magnetic conductive portion 22 and the magnetic portions 23 by dash lines. The magnetic conductive portion 22 is not magnetic, the two magnetic portions 23 are magnetic and disposed with same poles facing each other, and the coil 3 surrounds an outer periphery of the magnetic conductive portion 22. Similarly, the upper end and the lower end of the coil 3 protrude to an outside of the magnetic conductive portion 22 and surround the two magnetic portions 23, thereby improving the utilization of the magnetic field. In the embodiment shown in FIG. 16, the magnetic portions 23 and the magnetic conductive portion 22 are arranged in the vibration direction of the vibration assembly 2.

In a preferred implementation, referring to FIG. 17, the vibration assembly 2 includes a magnet 21 and a magnetic conductive plate 20. At least two magnetic conductive plates 20 are provided. Two adjacent magnetic conductive plates 20 are connected by the magnet 21. In other words, the magnetic conductive plates 20 are connected to both ends of the magnet 21. The magnet 21 is magnetized in the vibration direction, and the magnetic conductive plates 20 and the magnet 21 are arranged in the vibration direction. In this implementation, one coil 3 surrounds an outer periphery of at least one magnetic conductive plate 20. Preferably, one coil 3 surrounds an outer periphery of each of the two magnetic conductive plates 20, and directions of currents in two adjacent coils 3 are opposite at a same moment. It may be understood that the structure of the housing 1 may be adaptively changed. For example, a quantity and positions of the mounting holes 12 may be changed correspondingly for mounting in a corresponding coil 3. In addition, the vibration assembly 2 in this implementation may be of a split type or may be of an integral type.

The present invention further provides bone conduction glasses, including the bone conduction vibration sound producing apparatus described above. The bone conduction glasses further include a strip-shaped temple. The bone conduction vibration sound producing apparatus is strip-shaped, and is disposed in the temple. Because the bone conduction vibration sound producing apparatus is strip-shaped and has a shape matching that of the temple, a cross-sectional area of the temple can be effectively reduced, making it more comfortable to wear the bone conduction glasses.

As a preferred implementation, an aspect ratio (a ratio of a length a to a width b) of the bone conduction vibration sound producing apparatus ranges from 1.2 to 8. Further optionally, the aspect ratio is any value within a range of 3 to 5. Still further optionally, the aspect ratio of the bone conduction vibration sound producing apparatus is 4. The setting of an appropriate aspect ratio helps to improve the performance of the bone conduction vibration sound producing apparatus while fully utilizing a space. Apparently, a bone conduction vibration unit has a large aspect ratio and a small width and a small thickness. Therefore, the temple can be made thinner, making wearing more comfortable, convenient, and aesthetic.

The present invention further provides a wearable device. The wearable device may be, for example, a headset, glasses, a helmet, or another device suitable for wearing on a head, and includes the bone conduction vibration sound producing apparatus described above.

The foregoing descriptions are merely specific implementations of the present invention, and any other improvements made based on the idea of the present invention shall fall within the protection scope of the present invention.

What is claimed is:

1. A bone conduction vibration sound producing apparatus, comprising:
a housing, provided with an accommodating cavity;
a vibration assembly, provided in the accommodating cavity;
the coil, fixed with respect to the housing and surrounding an outer periphery of the vibration assembly, a flexible circuit board connected to the coil being disposed outside the housing, and the flexible circuit board being disposed at an end of the housing in a length direction, and being configured to be connected to an external control circuit; and
two elastic members, the two elastic members being respectively connected to two ends of the vibration assembly, and being both connected to the housing.

2. The bone conduction vibration sound producing apparatus according to claim 1, wherein the bone conduction vibration sound producing apparatus is strip-shaped, the vibration assembly, the coil, and the elastic members are also strip-shaped, and length directions of the bone conduction vibration sound producing apparatus, the housing, the vibration assembly, the coil, and the elastic members are consistent.

3. The bone conduction vibration sound producing apparatus according to claim 1, wherein the two elastic members are respectively connected to the two ends of the vibration assembly in a vibration direction, the housing is provided with an opening along the two ends of the vibration assembly in the vibration direction, to allow the vibration assembly to be mounted in the accommodating cavity through the opening, each elastic member comprises an outer support and a connecting arm, the outer support is connected to an end surface of an opening end of the housing, one end of the connecting arm is connected to the outer support, and the other end of the connecting arm is connected to the vibration assembly.

4. The bone conduction vibration sound producing apparatus according to claim 3, wherein the connecting arm extends in a length direction of the elastic members.

5. The bone conduction vibration sound producing apparatus according to claim 3, wherein the connecting arm comprises a base portion connected to the outer support, a connecting portion connected to a first end surface of the vibration assembly, and an elastic portion connected between the base portion and the connecting portion, and the connecting arm extends from the base portion in a length direction of the elastic members.

6. The bone conduction vibration sound producing apparatus according to claim 3, wherein the vibration assembly comprises a plane of symmetry perpendicular to a length direction of the vibration assembly, a connecting portion and a base portion of the elastic members are respectively located on two sides of the plane of symmetry, and the connecting arms of the two elastic members are centrosymmetric with respect to a center of gravity of the vibration assembly.

7. The bone conduction vibration sound producing apparatus according to claim 5, wherein the elastic portion is disposed obliquely toward a side on which the vibration assembly is located; or
the connecting portion protrudes toward a side on which the vibration assembly is located with respect to the elastic portion; or
a spacer plate is connected between the connecting portion and the vibration assembly.

8. The bone conduction vibration sound producing apparatus according to claim 3, wherein the outer support comprises a first surface connected to the housing and a second surface disposed opposite to the first surface, and in a vibration process of the vibration assembly, the connecting arm does not protrude from the second surface of the outer support.

9. The bone conduction vibration sound producing apparatus according to claim 3, wherein a wider part with a width W1 greater than a width W2 of the remaining part of the accommodating cavity is provided at each of two ends of the accommodating cavity in a length direction, and the wider part is in communication with the end surface of the opening end of the housing adjacent to the wider part; and
a width W3 of each of two ends of a cavity configured to accommodate the connecting arm of the outer support in a length direction is greater than a width W4 of the remaining part of the cavity.

10. The bone conduction vibration sound producing apparatus according to claim 5, wherein the outer support is annular, the outer support comprises two first rod bodies disposed opposite and two second rod bodies that are respectively connected between the two first rod bodies, the first rod bodies and the second rod bodies respectively extend in a length direction and a width direction of the bone conduction vibration sound producing apparatus, and the base portion is connected between the two first rod bodies and are not in contact with the second rod bodies.

11. The bone conduction vibration sound producing apparatus according to claim 5, wherein at least one hollowed-out hole is opened in the elastic portion, and stiffness and strength of the elastic portion are adjusted by controlling an area of the hollowed-out hole.

12. The bone conduction vibration sound producing apparatus according to claim 1, wherein the vibration assembly comprises a magnetic conductive plate and two magnets connected at two ends of the magnetic conductive plate, the two magnets are disposed with same poles facing each other, the coil surrounds an outer periphery of the magnetic conductive plate, and the magnets and the magnetic conductive plate are arranged in a vibration direction of the vibration assembly; or
the vibration assembly comprises a magnetic conductive portion and two magnetic portions that are respectively located on two sides of the magnetic conductive portion, the two magnetic portions are disposed with same poles facing each other, the coil surrounds an outer periphery of the magnetic conductive portion, and the magnetic portions and the magnetic conductive portion are arranged in a vibration direction of the vibration assembly; or
the vibration assembly comprises a magnet and two magnetic conductive plates connected at two ends of the magnet, the magnet is magnetized in a vibration direction of the vibration assembly, one coil surrounds an outer periphery of at least one magnetic conductive plate, and the magnet and the magnetic conductive plate are arranged in the vibration direction of the vibration assembly.

13. The bone conduction vibration sound producing apparatus according to claim 1, wherein the housing is provided with one or more bosses configured to limit a position of the coil in a height direction.

14. The bone conduction vibration sound producing apparatus according to claim 13, wherein a mounting hole configured to mount the coil is opened in an outer peripheral surface of the housing, and the mounting hole is a blind hole or a through hole; and
the outer peripheral surface comprises two first side surfaces disposed opposite and two second side surfaces disposed opposite, the first side surfaces extend in the length direction of the housing, the second side surfaces extend in a width direction of the housing, and the mounting hole is opened in the first side surfaces or the second side surfaces.

15. The bone conduction vibration sound producing apparatus according to claim 14, wherein an opening of the mounting hole gradually expands toward an outside.

16. The bone conduction vibration sound producing apparatus according to claim 14, wherein the boss protrudes into the mounting hole.

17. The bone conduction vibration sound producing apparatus according to claim 13, wherein all the bosses abut against an upper end surface of the coil; or
all the bosses abut against a lower end surface of the coil; or
among the plurality of bosses, some bosses abut against an upper end of the coil, and some bosses abut against a lower end of the coil.

18. The bone conduction vibration sound producing apparatus according to claim 14, wherein the housing is integrally formed; or
the housing comprises an upper casing and a lower casing connected to each other, and a connecting surface between the upper casing and the lower casing passes through the mounting hole.

19. The bone conduction vibration sound producing apparatus according to claim 1, wherein an aspect ratio of the bone conduction vibration sound producing apparatus ranges from 1.2 to 8.

20. The bone conduction vibration sound producing apparatus according to claim 19, wherein the aspect ratio of the bone conduction vibration sound producing apparatus ranges from 3 to 5.

21. The bone conduction vibration sound producing apparatus according to claim 1, wherein a material of the housing is plastic, aluminum or stainless steel; and
a material of the elastic members is stainless steel, plastic or beryllium copper.

22. A wearable device, comprising the bone conduction vibration sound producing apparatus according to claim 1.
